(19) United States
(12) Patent Application Publication
(10) Pub. No.: US 2002/0052702 A1
(43) Pub. Date: May 2, 2002

(54) Statistical control method for proportions with small sample sizes

(76) Inventor: Kevin A. Keller, St. Charles, MO (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/797,391

(22) Filed: Mar. 1, 2001

Related U.S. Application Data
(60) Provisional application No. 60/232,203, filed on Sep. 13, 2000.

(51) Int. Cl. G06F 19/00; G01N 37/00

(52) U.S. Cl. 702/84

(57) ABSTRACT

A method for determining whether a process having a small or large proportion of process features is in control by reviewing only small samples. The method comprises a data review and charting technique that readily identifies when a process is beginning to stray beyond acceptable control parameters so that corrective action may be initiated at an early stage before substantial output is affected. The method is applicable to any process sought to be reviewed, but is particularly useful with semiconductor wafer processing, such as wafer polishing

### BACKGROUND OF THE INVENTION

This invention relates to a statistical charting technique, and more particularly to a technique for controlling processes with small, or large, proportions when reviewing small sample sizes.

Statistical control chart techniques are popular control mechanisms for manufacturing processes. Control charts are based upon the theory that if the sampling is random, representative, and sufficient, the process can be monitored over time to verify stability and control. Control limits for charts are based upon the process average ±3 sigma increments, where sigma represents the standard error of the data. A more detailed discussion of statistical process control techniques can be found in A. DUNCAN, Quality Control and Industrial Statistics, pp. 417-475 (Richard D. Irwin, Inc 1986), or in D. J. WHEELER, Understanding Statistical Process Control, pp. 37-65 (SPC Press 1992).

An important assumption for this technique, when attempting to control proportions, is that the opportunity for defect (or lack of defect) of each unit remains constant. Such proportion is defined as p, where 0<p<1. Each unit should be independent of every other unit; that is, the results of one unit do not affect or influence the results of the next unit. This allows the distribution to be treated as a binomial distribution.

For binomial (proportional) data, p-charts and np-charts are popular charting techniques. P-charts are useful for determining process stability by finding a total percentage of defective units. Similarly, np-charts are useful for indicating the number of units in a defective sample. Where n represents the sample size used to calculate the proportion and p represents the estimate of the average proportion (0<p<1), the following criteria must be met in order for a p-chart to be of use.

n*p>5 AND n*(1−p)>5

Where p is nearer to 50 percent and the number of samples is large, a p-chart is a useful tool. For example, where the defect proportion is 35 percent (p=0.35) and the sample size is 20 (n=20), n*p=7 and n*(1−p)=13. Because both of these solutions are greater than 5, a p-chart is useful.

Certain applications may not meet these criteria when n is small and/or p is quite small or quite large. For these applications, the estimate of the control limits will be unusable. As a practical matter it may not be possible to obtain a sufficiently large sample size due to destructive testing issues, limitations of sampling product, inspection time, etc. In general, smaller sample sizes are preferred over larger, because they decrease cost burdens and speed data review.

C-charts can be used with count data, where a discrete number of events are recorded at regular time intervals. Based on a Poisson distribution, c-chart data is most often characterized as the number of defects per a given unit of space (time, area, volume, length, etc.). In certain applications, counting the number of defects in a sample of size n could represent Poisson data, and thus could be counted and charted. However, for small proportions, such as those less than 20 percent, and small sample sizes, there would be zero (0) counts for many samples. In practical terms, displaying of these counts on paper or computer may not easily reveal a change in performance level. For instance, the following record of events, having eight defects in 200 samples (a proportion of 4 percent), where zeros (0) indicate no defect and ones (1) indicate a defect, indicates no distinguishable trend.

00000000000000000000000000000100000000000000000100

00010000000000000010000000000010000000000000000010

00000000000000000000000000000000000000000000000100

00000000000000000000000010000000000000000000000000

The previous techniques are useful in many applications. Yet because of the problems associated with small sample sizes and low proportionality, these evaluative techniques are unable to detect processes as they trend beyond acceptable control parameters. Where the defect incidence is low and the number of samples from each production set is also small, the charts may allow a process to vary beyond acceptable control parameters for a long period of time before indicating that there may be a change in the proportion p, indicating a process problem. Long periods of processing outside control parameters can be extremely costly, because the process continues to produce defects, without a ready method of determining when the process is beginning to stray beyond acceptable control parameters. Current methods are unable to detect subtle changes in the average proportion of a data population. Because these methods are unable to timely identify a process beginning to stray beyond acceptable control parameters, a more sensitive tool is needed for determining if a system having a low proportion and small sample size is beginning to stray beyond control parameters.

### SUMMARY OF THE INVENTION

Among the several objects of this invention may be noted the provision of an improved methodology for analyzing whether a given process is within control parameters where the defect proportion is small or large and a small sample size is taken; the provision of such a methodology that increases the speed in determining whether the process is within control parameters; the provision of such a methodology that decreases the amount of data required to determine if a process is within control parameters; the provision of such a methodology that reduces the necessary sample size; the provision of such a methodology that is applicable to semiconductor wafer production processes; the provision of such a methodology that is applicable to semiconductor wafer polishing; and the provision of such a methodology that creates an easily understandable charting system that allows users to readily determine the present quality of a given process.

Generally, a method is disclosed for determining whether a process having a small proportion of process features is within control parameters by reviewing only small samples. The method comprises the step of performing a process that yields output, a small proportion of the output including the process feature, and arranging the output into production sets. The method further selects a number of samples at random from each production set and collects data indicative of a process feature from each sample of each production set. The method determines if any of the data indicate the presence of the process feature associated with each sample. The method orders the data into subgroups by beginning each new subgroup with the first sample of a production set whenever any of the samples from the previous production set include the process feature. The method further establishes at least one rule based on the proportion of the process features to the total output and a desired margin of error. The method monitors the data to determine if any of the at least one rule is violated.

In another embodiment of the present invention, a method is disclosed similar to the above method, but where the proportion of process features is large.

In a final embodiment of the present invention, a method is disclosed for determining whether a semiconductor wafer polishing process having a small proportion of process features is within control parameters by reviewing only small samples. The method comprises the steps of performing a wafer polishing process that yields polished wafers, arranging the wafers into cassettes, and selecting a number of sample wafers at random from each cassette. The method then collects data on dimpling from each sample wafer of each cassette and determines if any of the data indicate the presence of dimples associated with each sample wafer. The method then orders the data into subgroups by beginning each new subgroup with the first sample wafer of a cassette whenever any of the sample wafers from the previous cassette include a dimple. The method further establishes at least one rule based on the proportion of dimples to the total number of wafers and a desired margin of error and monitors the data to determine if any of the at least one rule is violated.

Other objects and features will be in part apparent and in part pointed out hereinafter.

### BRIEF DESCRIPTION OF THE DRAWINGS

FIG. 1 is a graph comparing a discrete versus a continuous Poisson distributed function;

FIG. 2 is a blank control chart of the present invention; and

FIG. 3 is a control chart of the present invention with portions of data filled out on the chart.

### DESCRIPTION OF THE PREFERRED EMBODIMENTS

Generally, the present invention relates to an improved statistical charting technique for controlling processes. Control charts, such as p-charts, np-charts and c-charts are generally inappropriate where the proportion of process features to the total output is quite small (or large) and the sample size is small. This is true because the probability of seeing more than one defect is very small. Given that each sample will be viewed as defective or non-defective, if the proportion is small, the problem reduces to finding a single defect within a sample. This gathering of systematic samples can be viewed as a Poisson process. If the data are from a Poisson process, then the “time” between Poisson events, e.g. seeing a defect, is exponentially distributed.

The preferred embodiment relates to processing semiconductor wafers. Semiconductor wafers are held within cassettes that typically hold 25 wafers. These cassettes protect the wafers from damage between processing and may hold more or fewer wafers without departing from the scope of the present invention. In the present case, each cassette is considered a single production set and the total population of wafers is referred to as production output. Testing each production set for quality is the focus of the present invention. Rather than testing the entire production output by removing and testing all 25 wafers from each production set, only four sample wafers are selected from each cassette and reviewed for quality. Various parameters indicative of wafer quality may be reviewed and collected to determine process quality. For instance, surface flatness characteristics are commonly used to determine wafer process quality. The present invention is optimized for wafer polishing process data related to surface flatness characteristics, such as surface dimpling. Flaws in flatness are undesirable because wafer surfaces must be substantially free from defects to be useful for various lithography processes. Dimples are one such defect, occurring where a wafer surface is slightly indented, rendering less accurate surface lithography. Although the preferred embodiment relates to the semiconductor industry, the current method could readily be applied to processes outside the semiconductor wafer industry.

In the preferred embodiment, a sample size of 4 wafers, taken from the production set (i.e., cassette) population of twenty-five, was available to measure at each sampling time. This sampling scheme is acceptable given the time and cost constraints of producing semiconductor wafers. Other sampling schemes involving greater or fewer production samples per production set are also contemplated as within the scope of the present invention and may be readily incorporated into the following analysis. The present invention is modeled for a representative semiconductor process, such as polishing, having a known defect rate of 3 percent, or p=0.03. The objective of the present invention is to detect increases in the defect rate p. Other defect are also contemplated as within the scope of the present invention and are readily applicable to the following analysis.

In statistical process control, standard p-charts are useful tools for reviewing samples to determine process performance. To be effective, however, they must satisfy the following requirements, where n is the sample size and p is the defect proportion:

n*p>5 AND n*(1−p)>5

In the present application, p-charts will not work because they fail to satisfy the first relationship. Namely, due to violation of the requirement that n*p >5 (4*0.03=0.12<<5), p-charts will not yield usable results due to the infrequency of defects. Even if it were economical to sample all 25 wafers from each cassette, the p-chart would remain an ineffective statistical tool where the proportion is less than 20 percent. Here, where the proportion is much less than 20 percent, no increase in the number of samples collected would satisfy the above criteria. Thus, p-charts are not feasible as process monitoring tools. Because p-charts are unusable, another statistical charting technique compatible with a small sampling rate and small proportions is needed. The following analysis provides the foundation for such a technique.

As mentioned previously, a binomial distribution assumes that the opportunity for defect (or lack of defect) of each unit remains constant. Assuming that the probability distribution function for the present application is a binomial distribution, the equation governing such a population is shown below, where x indicates the number of defective samples, n indicates the total number of samples and p indicates the proportion of defective samples:

$$P ( X = x ) = \frac{n !}{x ! \cdot ( n - x ) !} \cdot {p}^{x} \cdot {( 1 - p )}^{n - x}$$

where x=b 0, 1, 2, . . . , n

0<p<1

The probability distribution may be calculated for each value of x between 0 and 4, the total number of samples. For instance, the probability where x=0, p=0.03 and n=4 would be

$$\begin{matrix}P ( X = x ) = \frac{n !}{x ! \cdot ( n - x ) !} \cdot {p}^{x} \cdot {( 1 - p )}^{n - x} \\ = \frac{4 !}{0 ! \cdot ( 4 - 0 ) !} \cdot {( 0.03 )}^{0} \cdot {( 1 - 0.03 )}^{( 4 - 0 )} = 0.8853\end{matrix}$$

This probability value is recorded in the second column of Table 1 below, along with similarly calculated probabilities for the other given values of x. Moreover, the third column in Table 1 indicates the probability, of finding at least x defective samples within a production set. The probabilities disclosed in column three are calculated by summing the probability of finding a fewer number of defects and subtracting from 1, which essentially calculates the remaining probability of finding a defect. For instance, the probability of finding at least three defective samples within the four samples chosen from a particular production set is 0.01 percent (1-0.8853-0.1095-0.0051). In similar fashion, column four indicates the probability of finding x or fewer defects for each value of x. The probabilities disclosed in column four are calculated by summing the probability of finding a greater number of defects and subtracting from 1. For instance, the probability of finding 1 or fewer defects is 99.48 percent (1-0.0051-0.0001 -0.0000).

TABLE 1
Binomial Distribution
Where p = 0.0300, n = 4, np = 0.1200

| | Probability | Equal and | Equal and |
|---|---|---|---|
| X | at x | Above | Below |
| 0 | 0.8853 | 1.0000 | 0.8853 |
| 1 | 0.1095 | 0.1147 | 0.9948 |
| 2 | 0.0051 | 0.0052 | 0.9999 |
| 3 | 0.0001 | 0.0001 | 1.0000 |
| 4 | 0.0000 | 0.0000 | 1.0000 |

The expected value of defects in this sample is represented by

E[X]=n*p=4*0.03=0.12

This means that for any given sample of 4 wafers, one would expect to see 0.12 defects per sample, which is quite small. At this low level, an approximation to the Poisson distribution is possible. The probability distribution function for the Poisson is

$$P ( X = x ) = \frac{{ⅇ}^{- λ} \cdot {λ}^{x}}{x !}$$

where λ>0

x=0, 1, 2, . . . , ∞

The expected value (mean) of the Poisson distribution is λ, which is equal to the expected value from the binomial distribution (0.12). The probability distribution may be calculated for each value of x between 0 and 4, the total number of samples. For instance, the probability where x=0, p=0.03 and n=4 would be

$$P ( X = x ) = \frac{{ⅇ}^{- λ} \cdot {λ}^{x}}{x !} = \frac{{ⅇ}^{- 0.12} \cdot {0.12}^{0}}{0 !} = 0.8869$$

Table 2, shown below, is similar to Table 1 except that the probabilities are calculated using the Poisson distribution function rather than the Binomial distribution function.

TABLE 2
Poisson Distribution
Lambda = 0.1200

| | Probability | Equal and | Equal and |
|---|---|---|---|
| x | at x | Above | Below |
| 0 | 0.8869 | 1.0000 | 0.8869 |
| 1 | 0.1064 | 0.1131 | 0.9934 |
| 2 | 0.0064 | 0.0066 | 0.9997 |
| 3 | 0.0003 | 0.0003 | 1.0000 |
| 4 | 0.0000 | 0.0000 | 1.0000 |
| . . . | . . . | . . . | . . . |
| ∞ | 0.0000 | 0.0000 | 1.0000 |

Comparing the two distributions, as shown in Table 3 below, it is observed that the probabilities are quite similar, and that the majority of observations should be 0 out of 4 or 1 out of 4 (over 99 percent of the possibilities). This indicates that the Poisson distribution may be readily applicable to the wafer polishing process of the present invention. Moreover, the Poisson distribution is readily applicable to other binomial distributions that satisfy the criteria noted herein for the preferred embodiment.

TABLE 3
Binomial vs.
Poisson Distribution

| x | Binomial | Poisson |
|---|---|---|
| 0 | 0.8853 | 0.8869 |
| 1 | 0.1095 | 0.1064 |
| 2 | 0.0051 | 0.0064 |
| 3 | 0.0001 | 0.0003 |
| 4 | 0.0000 | 0.0000 |

A Binomial distribution can be approximated by a Poisson as n approaches infinity and p is small, which this example illustrates. Based upon this, we can treat the sampling process of the present invention as a homogeneous Poisson process (HPP), with a mean, μ, defined as the interarrival time. The situation is now reduced so that only two possibilities exist, the sample is defect-free or has a defect. For the preferred embodiment, the probability of detecting a defect sample when p=0.03 is:

P(x≧1)=1−P(x=0)=1−0.8853, or 0.1147.

This value now represents the interarrival time of defects, μ. To determine the expected number (mean) of defect-free samples between defective samples, one takes the reciprocal of the interarrival time, as shown below:

Mean between defective samples=1/μ=1/0.1147=8.72

In other words, about every nine samples, on average, a defect is detected. Given an HPP, there is an associated distribution of waiting times for successive occurrences. If events occur according to an HPP with a mean of μ, then the waiting times follow an exponential distribution with probability density function as defined below, where t represents time, or in this case the number of samples between each defect:

P(T=t)=μ·e^{-μ·t}, where t>0, μ>0

Two issues must then be addressed. First, exponential distributions are continuous distributions; that is, time t can take on any non-integer value greater than 0. In the preferred embodiment, the number of defect free samples between defective samples will represent time. The distribution of defect free samples is characterized by countable, discrete data. For a discrete distribution to approximate a continuous one, the value of the discrete distribution should closely approximate that of the continuous.

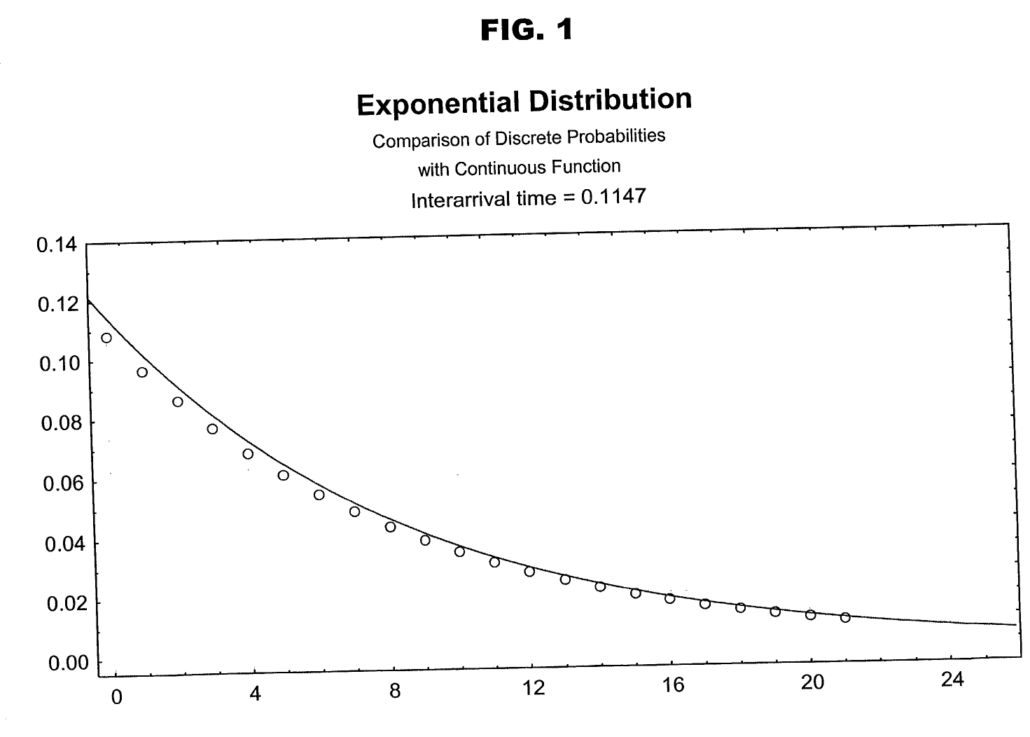

In this invention, because time (t) is represented as the number of samples between each defect, time becomes a discrete variable, rather than continuous. FIG. 1 illustrates a comparison between a discrete approximation of the exponential and the continuous exponential probability distribution for an interarrival time of 0.1147. These distributions are similar at all values, demonstrating that a discrete Poisson distribution closely approximates a continuous one.

Secondly, inclusive in the Poisson distribution is the possibility of two consecutive samples containing defects, where t=0. By definition, t>0, because it represents time. To address this issue, the cumulative distribution function is used to generate expected probabilities. The cumulative distribution function for the exponential distribution is defined as

F(t)=1−e^{-μ·t}

where p>0 (μ is the interarrival time between defective samples)

t>0 (t represents time)

For the situation where a defective sample was observed in a first cassette, followed by a cassette with defect-free samples and then followed by a cassette with a defective sample, t=1. A time value of 1 is consistent with the Poisson cumulative distribution function, because t is greater than zero, as required by the equality noted above. For two consecutive cassettes, each with at least one defective sample wafer, however, t=0, which yields F(0)=0. To eliminate this problem, t will be replaced by (t+1) in the cumulative distribution function, F(t). Thus,

F(t)=1−e^{-μ·(t+1)}

For example, where t=2, and μ=0.1147,

F(t)=1−e^{-μ(t+1)}=1−e^{-(0.1147)(2+1)}=1−e^{-0.3441}−1−0.7089=29.11%

Table 4 below lists the discrete probabilities for detecting a defective sample in a cassette that is preceded by a number of cassettes, indicated by t, having no defective samples.

TABLE 4
Binomial vs.
Poisson Distribution

| t | F(t) % |
|---|---|
| 0 | 10.84 |
| 1 | 20.50 |
| 2 | 29.11 |
| 3 | 36.80 |
| 4 | 43.65 |
| 5 | 49.75 |
| 6 | 55.20 |
| 7 | 60.05 |
| 8 | 64.38 |
| 9 | 68.24 |
| 10 | 71.68 |
| 11 | 74.75 |
| 12 | 77.49 |
| >>12 | 100.00 |

The probability for each individual value t will be determined by

F(t+1)−F(t), for t=0, 1, 2, . . . , ∞.

The objective of the present invention is to detect increases in the defect rate p. In order to facilitate this process, rules can be established for determining when the process is beginning to stray beyond acceptable control parameters. For example, the probability of finding defective samples in two consecutive cassettes corresponds to a t=0. Solving for F=(0) (referring to Table 4 above), the likelihood of finding a defect within two consecutive cassettes is 10.84 percent. This value is too large to set as control (reaction) limit, since almost 11 percent of the time, two defects will happen by chance alone. If this were the only rule, a process performing properly but creating samples in two consecutive cassettes with defects would be perceived, albeit improperly, as beyond acceptable control parameters. Therefore, a more developed set of rules can be derived, based upon the tables above, which minimizes the likelihood of a false positive.

In the preferred embodiment, rules are created using a Type I (α) error of 0.05, but any Type I error threshold can be used. The median value of the above table is approximately 5 cassettes, or production sets, corresponding to a 49.75 percent chance of finding two defects within 5 cassettes. Therefore, rules are created based upon probability theory of the likelihood that a series of observations could actually happen by chance alone. For instance, the probability of a randomly occurring series of five defective samples, where there are no more than four defect-free production sets immediately before each defective production set is calculated as follows:

P(five defective sets, each preceded by no more that four non-defective sets)=(0.4975)=0.0305

Thus, there is about a three percent chance that a process in control would yield 5 production sets in a row, each preceded by 4 or less production sets with no defects. Since this probability is smaller than the threshold value of 0.05 (5 percent), the user would conclude that if five production sets containing defects are each preceded by 4 or less production sets with no defects, then the defect rate of p=0.03 had significantly increased.

Because this probability is less than the alpha error of 5 percent, other rules can be developed similarly to add to the probability of indicating a potential defect. In the first preferred embodiment, two additional rules were added. The second rule states that where the process yields three consecutive subgroups, each subgroup containing three or fewer production sets, the process is varying beyond acceptable control parameters. The rule is calculated below using a discrete probability from Table 4.

3 defects, each preceded by two or less defect-free sets Probability=(0.3680)³=0.0498

The third rule states that where the process yields two consecutive production sets, each production set containing at least one process feature, the process is varying beyond acceptable control parameters. The rule is calculated below using the binomial probability from Table 1 for finding one defect in each cassette, and squaring it to yield the probability of finding defects in two consecutive cassettes.

2 production sets in a row with a defect (t=0) Probability=(0.1147)² 0.0132

When applying multiple rules, the errors from each rule compound the overall error rate. This overall error rate is defined as

$${α}_{overall} = 1 - {\prod }_{i = 1}^{j} ( 1 - {α}_{i} ) ,$$

For these three rules, the overall error rate is

αₒᵥₑᵣₐₗₗ=1−(1−0.0305)(1−0.0498)(1−0.0132)

αₒᵥₑᵣₐₗₗ=0.0909

Thus, when applying the first preferred rules, the likelihood of breaking any of the three rules, when the process is functioning properly, is about 9 percent. Other rules may also be added. For instance, a second set of preferred rules may include a rule focussed on the number of defective samples found within a particular production set. Specifically, finding two or more defects in the same production set would be evidence that the proportion had changed from p=0.03. The probability for finding two or more defects within a production set may be found in Table 1, column 3, where the probability of finding two or more is 0.0052. Adding this final rule to the other three, the overall error rate becomes

αₒᵥₑᵣₐₗₗ=1−(1−0.0305)(1−0.0498)(1−0.0132)(1−0.0052)

αₒᵥₑᵣₐₗₗ=0.0957

In sum, the preferred rules are as follows. Rule 1 states that p has likely changed when five subgroups in a row each contain less than five production sets. Rule 2 states that p has likely changed when three subgroups in a row each contain less than three production sets. Rule 3 states that p has likely changed when two consecutive productions sets each contain at least one defective wafer. Rule 4 states that p has likely changed when two defective wafers are found within the four samples from a single cassette. Determining and developing rules is infinite, based upon the initial defect rate p, the desired alpha level protection, and how many rules are desired. A variety of other rules may be developed according to the process disclosed herein without departing from the scope of the present invention.

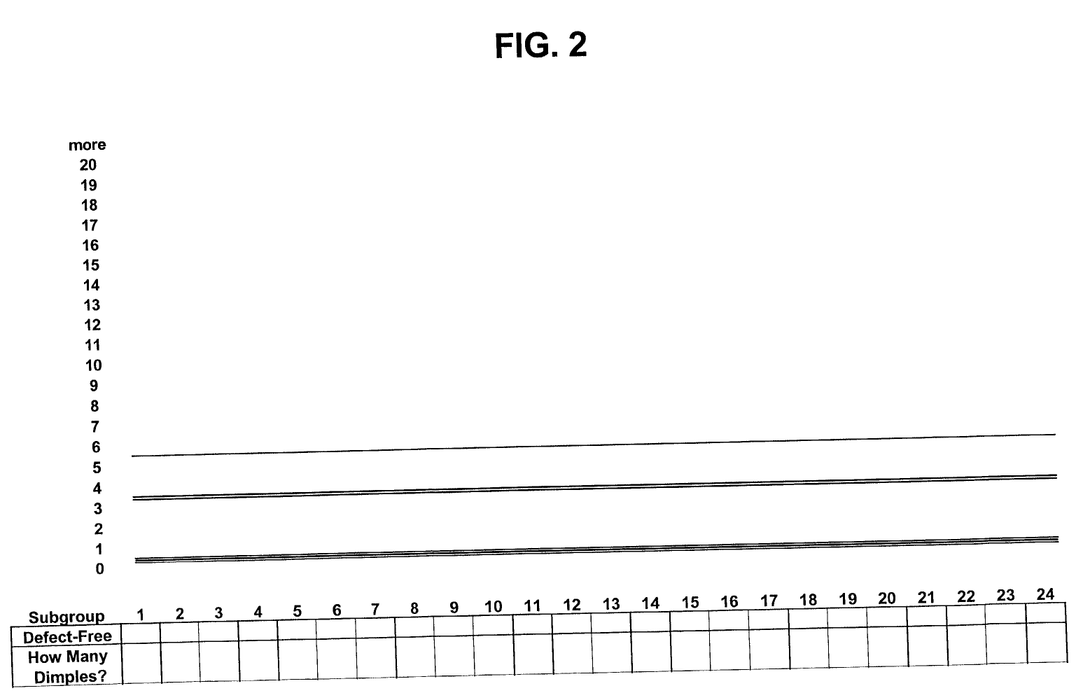

Once a sample has been tested and data recorded, the results are plotted in a chart for ease and clarity in applying the rules. A template of the chart, shown without any data, is depicted in FIG. 2. To begin using the chart, the first four samples are taken from a production set, or cassette. If the cassette is defect-free (i.e., each sample wafer is dimple-free) an X is marked in row 1. Each subsequent defect-free cassette (as determined by the four samples) is denoted by an X added to the first column, or data subgroup. When a defect is detected in a cassette, a final X is marked in that column, or subgroup, and the number of defects within the cassette is noted at the bottom. If the next cassette contains a defect, an X is marked in the 0 row of the next subgroup. Otherwise, an X is marked in row 1 of the next subgroup and the procedure continues.

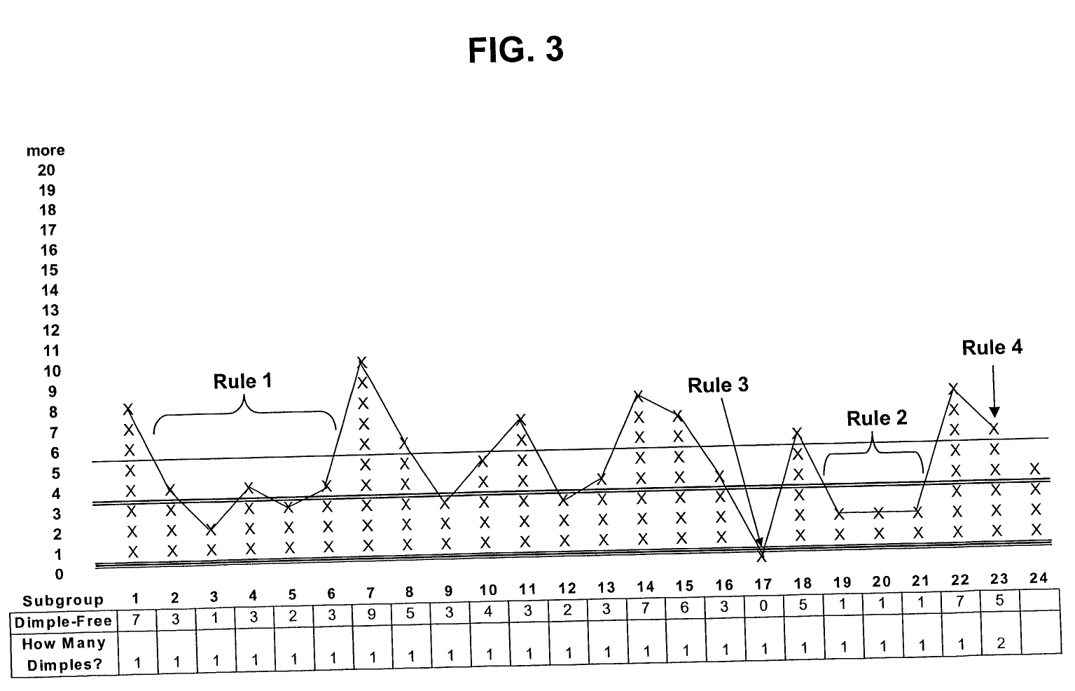

Guidelines can be placed across the chart to help in assessing control (FIG. 2). For the rules applicable to the present invention, any X in the 0 row, below the triple horizontal line, is deemed beyond acceptable control parameters because it violates rule 3. A single line placed above row 5, allows the user to assess if five subgroups in a row are below that line, indicating a violation of rule 1. A double line placed between rows three and four allows the user to assess if three subgroups in a row are below the double line, violating rule 2. Violations of rule 4, where two defective samples are found in a single production set, are assessed at the time of measurement and recorded in the “How Many Dimples” row, as shown in column 23 FIG. 3.

FIG. 3 shows a control chart filled out, illustrating violations of the various rules, any of which would indicate that the process is likely beyond acceptable control parameters. For example, in data subgroup 1, Xs are listed in rows 1 through 8, indicating that the samples from seven production sets, or cassettes, yield no defects. The eighth cassette, however, yields a single defective sample wafer. Thus, an X is marked in row eight and subgroup 1 is closed, holding eight production sets. Because the next production set contains no defects, an X is placed in row 1 of subgroup 2. As more production sets are reviewed, more Xs are added to subgroup 2, until a production set having a defect is found. This process is repeated with each successive production set and the results are plotted as the wafers are tested. A line may be drawn between the last production set of each subgroup to indicate the size of each subgroup, making application of the rules easier. An operator can then review the data on the chart as it is recorded so that as soon as a rule is violated, the process may be reviewed as potentially beyond acceptable control parameters.

For instance, subgroups 2 through 6 on FIG. 3 violate the first rule, because these five sequential subgroups each contain less than five production sets. After collecting and plotting the data up to the fourth production set in subgroup five, an operator would note the violation of the first rule and begin to diagnose the problem. Without the present method, an operator would merely know that six defects have occurred within 100 samples, yielding a defect rate of six percent. Although greater than the expected rate of three percent, such a rate would likely not alert the operator to a problem, especially given the relatively small population of samples collected thusfar.

Similarly, subgroups 19 through 21 each have three or fewer production sets per subgroup. This violates rule 2, indicating that the error rate of the process has likely risen above the expected three percent. Violations of rule 4 are recorded in the table below each subgroup, as shown in FIG. 2. Violations of rule 4 occur whenever each production set, or cassette, contains more than one defective wafer. Finally, violations of rule three are noted by placing an X in row 1, where a cassette containing a defective wafer is immediately preceded by another cassette with a defective wafer. Violation of any of these rules tends to show that the error rate p of the process has risen above three percent. Other rules may also be established according to the method described above to identify whether a process is beginning to stray beyond acceptable control parameters.

In view of the above, it will be seen that the several objects of the invention are achieved and other advantageous results attained.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A method for determining whether a process having a small proportion of process features is within control parameters by reviewing only small samples, comprising the steps of:
performing a process that yields output, a small proportion of said output including the process feature;
arranging the output into production sets;
selecting a number of samples at random from each production set;
collecting data indicative of a process feature from each sample of each production set;
determining if any of the data indicate the presence of said process feature associated with each sample;
ordering the data into subgroups by beginning each new subgroup with the first sample of a production set whenever any of the samples from the previous production set include said process feature;
establishing at least one rule based on the proportion of said process features to the total output and a desired margin of error;
monitoring said data to determine if any of said at least one rule is violated.

2. A method as set forth in claim 1 wherein the performing step further comprises a manufacturing process.

3. A method as set forth in claim 2 wherein the performing step further comprises a semiconductor wafer manufacturing process.

4. A method as set forth in claim 3 wherein the performing step further comprises a semiconductor wafer polishing process.

5. A method as set forth in claim 4 wherein the process features are dimples in semiconductor wafers.

6. A method as set forth in claim 3 wherein each production set comprises a cassette of wafers and wherein the selecting step further comprises a number of wafers from the cassette, the number being less than the total number of wafers held in the cassette.

7. A method as set forth in claim 6 wherein the selecting step further comprises selecting four samples from each cassette.

8. A method as set forth in claim 7 wherein the monitoring step further comprises plotting the number of production sets within each subgroup on a chart for visual comparison of the size of each data subgroup relative to the other data subgroups.

9. A method as set forth in claim 7 wherein said at least one rule of the establishing step is selected from a group including:
(a) a first rule that where the process yields five consecutive subgroups, each subgroup containing five or fewer production sets, the process is varying beyond acceptable control parameters;
(b) a second rule that where the process yields three consecutive subgroups, each subgroup containing three or fewer production sets, the process is varying beyond acceptable control parameters;
(c) a third rule that where the process yields two consecutive production sets, each production set containing at least one process feature, the process is varying beyond acceptable control parameters; and
(d) a fourth rule that where the process yields a production set containing two process features, the process is varying beyond acceptable control parameters.

10. A method as set forth in claim 9 wherein said establishing step comprises establishing two of said rules (a) through (d).

11. A method as set forth in claim 9 wherein said establishing step comprises establishing three of said rules (a) through (d).

12. A method as set forth in claim 9 wherein said establishing step comprises establishing all four of said rules (a) through (d).

13. A method as set forth in claim 9 wherein said establishing step comprises establishing rules (a), (b) and (c).

14. A method as set forth in claim 1 wherein the monitoring step further comprises plotting the number of production sets within each subgroup on a chart for visual comparison of the size of each data subgroup relative to the other data subgroups.

15. A method as set forth in claim 1 wherein said at least one rule of the establishing step is selected from a group including:
(a) a first rule that where the process yields five consecutive subgroups, each subgroup containing five or fewer production sets, the process is varying beyond acceptable control parameters;
(b) a second rule that where the process yields three consecutive subgroups, each subgroup containing three or fewer production sets, the process is varying beyond acceptable control parameters;
(c) a third rule that where the process yields two consecutive production sets, each production set containing at least one process feature, the process is varying beyond acceptable control parameters; and
(d) a fourth rule that where the process yields a production set containing two process features, the process is varying beyond acceptable control parameters.

16. A method as set forth in claim 15 wherein said establishing step comprises establishing two of said rules (a) through (d).

17. A method as set forth in claim 15 wherein said establishing step comprises establishing three of said rules (a) through (d).

18. A method as set forth in claim 15 wherein said establishing step comprises establishing all four of said rules (a) through (d).

19. A method as set forth in claim 15 wherein said establishing step comprises establishing rules (a), (b) and (c).

20. A method for determining whether a process having a large proportion of process features is within control parameters by reviewing only small samples, comprising the steps of:
performing a process that yields output, a small proportion of said output including the process feature;
arranging the output into production sets;
selecting a number of samples at random from each production set;
collecting data indicative of a process feature from each sample of each production set;
determining if any of the data indicate the lack of said process feature associated with each sample;
ordering the data into subgroups by beginning each new subgroup with the first sample of a production set whenever any of the samples from the previous production set fail to include said process feature;
establishing at least one rule based on the proportion of said process features to the total output and a desired margin of error;
monitoring said data to determine if any of said at least one rule is violated.

21. A method for determining whether a semiconductor wafer polishing process having a small proportion of process features is within control parameters by reviewing only small samples, comprising the steps of:
performing a wafer polishing process that yields polished wafers, a small proportion of said wafers including the process feature;
arranging the wafers into cassettes;
selecting a number of sample wafers at random from each cassette;
collecting data on dimpling from each sample wafer of each cassette;
determining if any of the data indicate the presence of dimples associated with each sample wafer;
ordering the data into subgroups by beginning each new subgroup with the first sample wafer of a cassette whenever any of the sample wafers from the previous cassette include a dimple;
establishing at least one rule based on the proportion of dimples to the total number of wafers and a desired margin of error;
monitoring said data to determine if any of said at least one rule is violated.

22. A method as set forth in claim 21 wherein the selecting step further comprises selecting a number of wafers less than the total number of wafers held in the cassette.
